(19) United States
(12) Patent Application Publication
(10) Pub. No.: US 2007/0239533 A1
(43) Pub. Date: Oct. 11, 2007

(54) Allocating and monetizing advertising space in offline media through online usage and pricing model

(76) Inventors: Susan Wojcicki, Los Altos, CA (US); Gokul Rajaram, Los Altos, CA (US)

Correspondence Address: FISH & RICHARDSON P.C., PO BOX 1022, MINNEAPOLIS, MN, 55440-1022, US

(21) Appl. No.: 11/394,209

(22) Filed: Mar. 31, 2006

(51) Int. Cl. G06Q 30/00

(52) U.S. Cl. 705/14

(57) ABSTRACT

Allocating and monetizing advertising space in offline media through online usage and pricing model. Offline media sources request advertisements for available ad space in their publications. An advertising server that stores advertisement messages associated with online retailers selects one or more advertisements to fill the unallocated ad space. An ad copy is created containing the selected advertisement messages is created and sent to the offline media source for publication. The ad copy contains identification information for online replica content with electronic versions of the selected advertisements. The online replica content may also contain contact information for each of the represented online retailers thereby enabling realization of advertising revenue for the offline published advertisement message when viewers contact the advertisers using this contact information.

### FIELD OF THE INVENTION

The present invention relates to print and electronic advertising and more particularly to allocating and monetizing advertising space in an offline publication through online ad usage and pricing models.

### BACKGROUND OF THE INVENTION

Advertising revenue rather than subscriptions provides the revenue base for most media sources both conventional and online. Ad space is sold, ad copy is created and the ad copy appears at an agreed upon location or date/time in the publisher's media. Particularly with paper-based publications, formulating layout is a labor intensive process that requires significant lead time to determine where articles and advertisements will appear. As a result, offline media publishers may be left with unallocated ad space that could otherwise be occupied with paying ads. Though publishers may be willing to accept less revenue for this space, because of the time involved in creating ads it may be more difficult to market on a short notice.

Online advertisers tend to be more dynamic because of the speed with which a website can be created and the relative ease of changing electronic ads and hyperlinks. However, in an offline media, ad space is often sold on a cost per impression basis (that is based on an assumption that a fraction of the magazine's total circulation views the ad). Online advertisers are accustomed to purchasing ad space on a referral or cost-per-click basis. That is, the advertiser pays a fee for another website that directs a customer to the advertiser's website. Online retailers, who may be smaller than conventional brick and mortar goods and services sellers may be reluctant to purchase ad space on a cost-per-impression basis because of the lack of measure of effectiveness and relatively large expense. Other problems and drawback exist with existing systems.

### SUMMARY OF THE INVENTION

Accordingly, at least one exemplary embodiment may provide a method for allocating advertisements to offline media advertising space. The method according to this embodiment may comprise receiving an indication of available advertising space from an offline media source, selecting at least one advertisement message associated with an advertiser to use in the available advertising space, transmitting the at least one advertisement message to the offline media source, the at least one advertisement message comprising a reference to online replica content, and creating the online replica content.

In another exemplary embodiment, a system for allocating advertisements to available offline media advertising space may be provided. The system according to this embodiment may comprise an advertising server adapted to store a plurality of advertisement messages, receive requests from offline media sources for advertisements, select one or more advertisement messages from the plurality of messages to satisfy the request, return an advertisement copy containing the one or more selected messages and identification information for online replica content, create the online replica content, wherein for each of the one or more advertisement messages, the online replica content contains contact information for contacting an advertiser associated with the advertisement message, and charge advertisers on a referral basis when a viewer contacts the advertiser using the contact information.

Yet another exemplary embodiment may provide an automated method for selling advertisement space in offline media. The method according to this embodiment may comprise creating a database of electronic advertising messages, based on a received request from an offline media source for advertisement messages, generating an advertisement copy containing at least one of the electronic advertising messages, creating an online replica content containing the advertisement copy, and transmitting the advertisement copy to the offline media source, wherein the advertisement copy comprises identification information of the online replica content.

In still an additional embodiment, a system for selling unallocated ad space in offline media to online vendors may be provided. The system according to this embodiment may comprise at least one offline media source, a plurality of advertisement messages, each message associated with an online vendor, and an advertisement server, wherein the advertisement server is adapted to select at least one advertisement message, create an online replica website containing the at least one advertisement message, and generate an advertisement copy containing the selected at least one advertisement message and a URL for the online replica website.

These and other embodiments and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a system level block diagram illustrating components of an automated system for allocating available advertising space in an offline media using an online usage and pricing model according to at least one embodiment of the invention;

FIG. 2 is a block diagram illustrating the various components of an advertising server for allocating available advertising space in an offline media using an online usage and pricing model including links to a plurality of online retailers according to at least one embodiment of the invention;

FIG. 3 is a flow chart of an exemplary method for providing ad copy of electronic retailers to an offline media source according to at least one embodiment of the invention;

FIG. 4 is a flow chart of an exemplary method for selecting particular advertisement messages to appear in the offline media in accordance with at least one embodiment of the invention;

FIG. 5 is a flow chart of an exemplary method for realizing revenue through an online pricing and usage model for print advertisements according to at least one embodiment of the invention;

FIG. 6 is a sample offline line advertisement message generated by the system for allocating available advertising space in an offline media using an online usage and pricing model according to at least one embodiment of the invention;

FIG. 7 is another sample offline advertisement message generated by the system for allocating available advertising space in an offline media using an online usage and pricing model according to at least one embodiment of the invention; and

FIG. 8 is a viewers interface window illustrating an exemplary view of an online replica website created by the system for allocating available advertising space in an offline media using an online usage and pricing model including links to a plurality of online retailers according to at least one embodiment of the invention;

### DETAILED DESCRIPTION

The following description is intended to convey a thorough understanding of the embodiments described by providing a number of specific embodiments and details involving systems and methods for automatically allocating advertising space in an offline media source using an online pricing and usage model. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

### System Overview

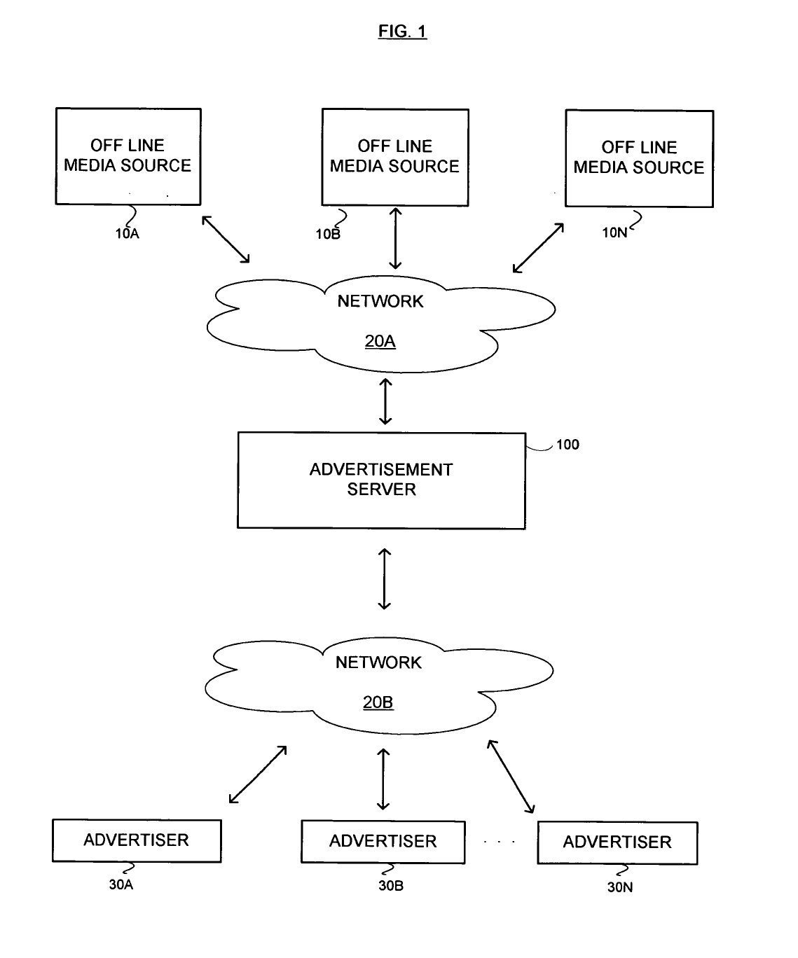

Referring now to FIG. 1, a system level block diagram illustrating components of an exemplary automated system for allocating available advertising space in an offline media using an online usage and pricing model according to at least one embodiment of the invention is illustrated. The system comprises a plurality of advertisers 30A, 30B . . . 30N in electronic communication with an advertising server 100 via a communication network 20B. In various embodiments the communications network 20B may be the Internet. However, the communications network may also be a telephone network, local area network (LAN), wide area network (WAN), ad-hoc network, or other suitable network. Although the advertiser server 100 is depicted as a single block in the figure, it may comprise multiple distributed components. The system may also comprise one or more offline media sources 10A, 10B, . . . 10N who may also communicate with the advertising server 100 (e.g., over communication network 20A). As will be discussed in greater detail herein, offline media sources 10A, 10B, . . . , 10N, may comprise newspaper publishers, magazine publisher, journal publishers, television producers, etc. In various embodiments, network 20A may be the same as network 20B, such as, for example, the Internet. However, network 20A may also be a different network than 20B and may be any type of network.

In the exemplary system of FIG. 1, as will be discussed in greater detail herein, advertisers 30A-30N may interact with the advertising server 100 to purchase and/or pay for advertisements, to upload advertisement messages and other advertising copy, and/or to perform other functions. It should be appreciated that as used herein, the phrase “advertisement messages” will refer to any document, data set or other object that identifies a retailer or brand owner and that refers to at least one product, service, class of products and/or class of services. In various embodiments, advertisers may create their own advertisement messages and upload them to the advertising server. However, in various embodiments, the advertisement messages may be created automatically, manually or through a mixture of automated and manual processes at the advertising server 100 using information supplied by the advertisers 30A-30N. Furthermore, as used herein, the phrase “advertising copy” or “ad copy” will be used to refer to the actual layout, that is the visual appearance, of an advertisement message.

With continued reference to FIG. 1, offline media sources, also referred to herein as publishers 10A, 10B, . . . , 10N, may interact with the advertising server 100 to request and/or obtain advertisements to fill unallocated space in their respective publications. As used herein, publications may include newspapers, magazines, television, or any other suitable offline media source. As will be discussed in greater detail herein, when the advertisement server creates ad copy for one of the offline publishers 10A-10N, the actual ad copy may be forwarded to the offline publishers. Then, in various embodiments, either before, after or contemporaneous to forwarding the ad copy, online replica content will be created. In various embodiments, the online replica content will be a website. In various embodiments, the website will have a URL specific to the offline publisher for whom the ad copy has been generated. In various embodiments, the ad copy will include the URL for this online replica website. However, other types of online content may be used. For example, the ad copy may have a number to which the user sends a text message and receives or access the online content in response thereto. Also, the ad copy may contain an email address to which the viewer sends an email and receives a response thereto including the online content or including a link to reach the online content. While in a preferred embodiment, the online content may be a website and the ad appearing in the offline media source may display the URL for this website with the advertisement, it should be appreciated that other methods may be used as discussed above. That is, the content may be pushed to a user appliance based on a text message request, may be sent in an email, a link thereto may be provided in an email or text message, or other method of accessing online content may be employed.

As will be discussed herein, the advertising server 100 may comprise a database including a plurality of advertisement messages, a web server, commerce module and communications module to facilitate communication and commerce between advertisers and offline media sources.

### Exemplary System Architecture

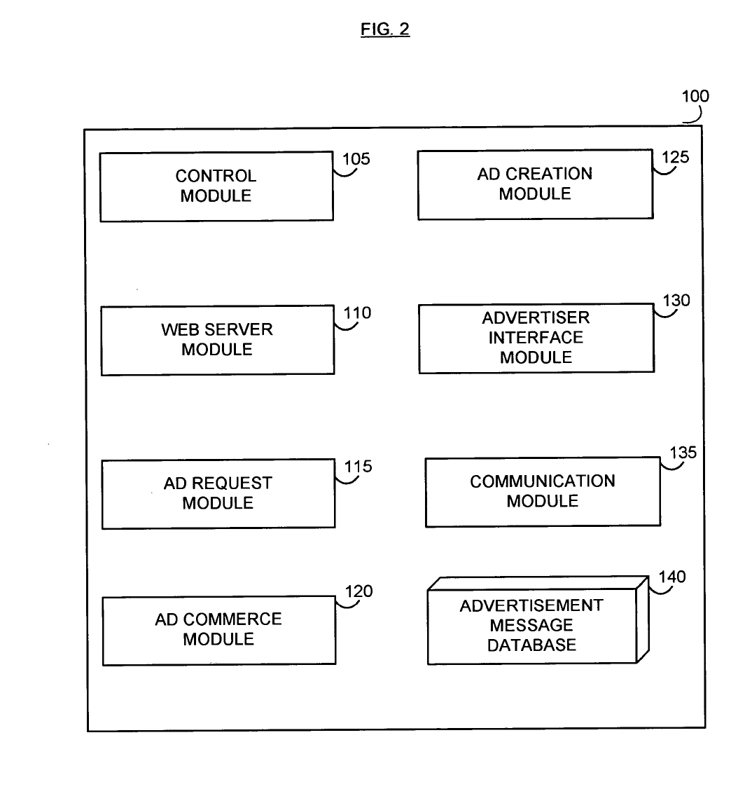

Referring now to FIG. 2, an exemplary system architecture for an advertising server for selling unallocated advertising space to offline media sources using an online pricing and usage model according to at least one embodiment of the invention is depicted. The server 100 comprises a plurality of different modules and databases which, in various embodiments, may provide functionality that enables the system to serve as a platform for commerce between online advertisers and offline media sources. In the example of FIG. 2, there is a control module 105, a web server module 110, an ad request module 115, an ad commerce module 120, an ad creation module 125, an advertiser interface module 130, a communications module 135 and an advertisement message database 140. It should be appreciated that each module may be configured as a software application executing on computer hardware, an application specific integrated circuit (ASIC), a combination of hardware and software, or other suitable configuration. Moreover, modules may be combined or broken into multiple additional modules. For example, the control module 105 may be one or more CPUs of the server 100, may be a DSP, or even an embedded processor and/or embedded operating system.

The communication module 135, such as, for example, a network interface card, modem, wireless transceiver or other network device and corresponding device drivers may enable communication (e.g., two-way) between both advertisers and offline media sources (publishers) and the server. As noted above, advertising messages, advertiser identification and price sensitivity information may be transmitted to the server 100 from entities wishing to purchase advertising space on a costs per click (otherwise known as referral) basis. Furthermore, offline media companies may transmit requests for a given quantity of advertising copy to occupy unallocated space in their publications and receive such ad copy from the server 100. The communication module 135 may facilitate communication with the server 200 by advertisers and offline media sources.

The ad request module 115 may serve as an interface between offline media sources wishing sell their unallocated advertising space and the advertising server 100. In various embodiments, an offline media source may contact the advertising server 100 by sending an electronic message or navigating to a website associated with the advertising server 100 and submitting a request. Through the ad request module 115, the offline media source may supply information relating to the nature, amount and quality of unallocated advertising space they are seeking to sell. In various embodiments, this information may be stored in a database in the server 100, such as database 140 or other database not shown in the example of FIG. 2.

After the request has been received, in various embodiments, the commerce module 120 may, based on the information supplied by the offline media source and information already supplied by various advertisers, select one or more advertiser's messages from those stored in the advertisement message database 140. As will be discussed in greater detail herein, the selection may be based on any of a number of factors including the nature of the offline media source, the nature of goods or services being advertised by the advertiser, the amount and quality of available space, pricing constraints of the advertiser, previously specified advertiser preferences, a pricing auction or other revenue-based consideration, and combinations and/or variations of any of these factors. Once the “winning” ads have been chosen, in various embodiments, the ad creation module 125 then creates an ad copy layout including advertising messages from the one or more selected ad messages that is of the approximate size and shape specified by the offline media source. It should be appreciated that in some embodiments, the offline media source may generate the ad copy based on information about the selected advertisers supplied by the advertising server 100. In various embodiments, the communication module 135 is used to transmit the selected ad messages and/or ad copy to the requesting offline media source. In various embodiments, the commerce module 120 may determine a pricing model to recover revenue from the advertiser. For example, in various embodiments, the commerce module may establish a pricing model whereby advertisers are charged on a referral or per click-through basis. Such advertising schemes are typically used with Internet-based banner-type advertisements. However, other pricing models may be used as well without departing from the spirit or scope of the invention.

In various embodiments, either the ad creation module 125 or web server module may create an online replica website having a URL that is specific to the particular offline media source for whom the advertising copy has been created. This online replica website may contain an online version of the advertisement that has been selected to appear in the previously unallocated space available in the offline media source. The URL for this online replica site may be listed in the ad copy and/or included with the ad messages sent to the requesting offline media source. In this manner, persons viewing the ad wishing to gain additional information regarding the advertised products and/or services may go to the online replica site in order to obtain additional information (e.g., the information may not be available from some other source). In various embodiments, the online replica site may include electronic hyperlinks to websites affiliated with each of the online advertisers represented therein, telephone number, email address, or other contact information. When a person viewing the online replica site selects one of these hyperlinks, the ad commerce module 120 may confirm that an effective revenue event (e.g., hyperlink click-through) has occurred and can charge the particular advertiser according to its predetermined pricing plan, such as for example on a cost per click-through or referral basis.

In various embodiments, advertisers may interface with the advertising server 100 through the advertiser interface module 130. Through this module, advertisers may upload advertising messages and/or other preference and identification module, may set up payment methods and specify pricing models and/or may supply other information. For example, advertisers may specify the kinds of offline media sources they would like their products and/or services associated with, particular offline media sources, particular geographical regions, etc. In various embodiments, this information may also be stored in the advertisement message database 140 or other database and may be used by the ad commerce module 120 to assist in determining which ad messages to select in response to a request from an offline media source.

It should be appreciated that each module depicted in the server 100 may operate autonomously or under the control of the control module 105. For example, in various embodiments, the control module may be a CPU of the server 100. Furthermore, it should be appreciated that the particular modules illustrated in FIG. 2 are exemplary only and should not be construed as either necessary or exhaustive. In various embodiments, it may be desirable to use more, less or even different modules than those illustrated in FIG. 2. It should also be appreciated that the advertising server 100 may also be configured as more than one server or a distributed network of servers and that the advertisement message database 140 may actually be located remote from the server 100 and accessible over a network. In various embodiments, access to the database 140 may occur in real or near real time so offline media sources can get a response sufficiently quickly to permit them to incorporate the selected ad copy in their publications.

### Exemplary Targeted Marketing Process

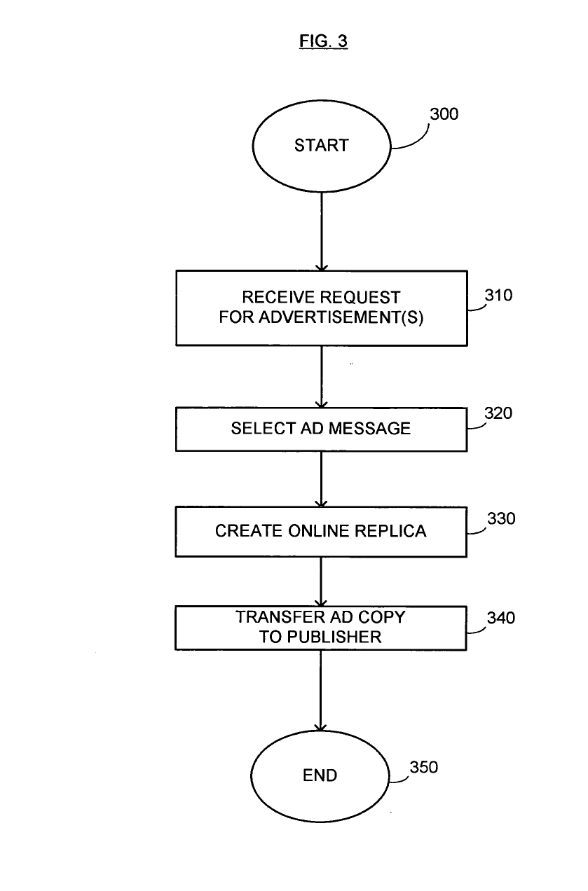

Referring now to FIG. 3, a flow chart detailing an exemplary method (e.g., automated) for providing ad copy of electronic retailers to an offline media source according to at least one embodiment of the invention is depicted. The method begins in block 300. In block 310, the advertising server receives a request for advertisements to fill unallocated advertising space. As discussed herein, in various embodiments, this may comprise receiving a request from an offline media source for advertisements to fill unallocated space in the offline media source's publication. The request may received as an electronic mail message, a web form, telephone call, facsimile, etc. The request may be processed automatically or be completed through human data entry or combinations of these methods. In various embodiments, the request may include information such as data fields specifying the nature of the offline media, the amount (i.e., physical dimensions, number of openings, number of pages, etc.), expected price, exclusions (i.e., based on exclusive agreements with other advertisers already present in the publication) and other suitable information.

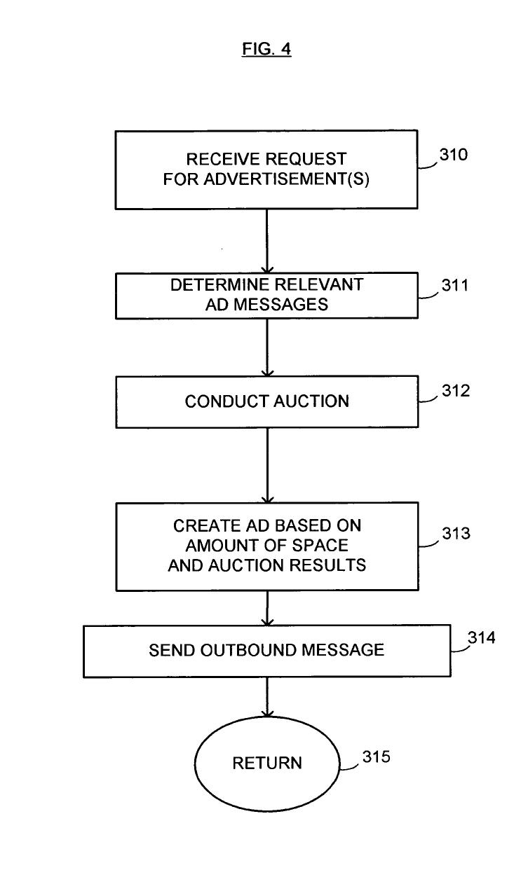

In block 320, based at least in part on information associated with and/or specified in the request, one or more advertisement messages are selected. As discussed herein, in various embodiments, the advertising server may maintain a database of available advertisement messages, or simply a database of advertisers with one or more fields describing their product or service and identifying them by name and/or with contact information. In various embodiments, as is discussed in greater detail in the context of FIG. 4, the server may first determine which advertisers are available, that is not excluded based on price, exclusions, or relevancy, and then conduct an auction or other price matching process to maximize advertising revenue. In various embodiments, advertisers are not charged at this point in the process.

In block 330, after one or more advertisers have been selected to satisfy the offline media source's request, an online replica website containing ad messages for the selected advertisers is created. The online replica website is specific to the requesting offline media source. In various embodiments, the online replica website may include information identical to the actual ad copy appearing in the offline media source. In various embodiments, the online replica website may include information that is merely similar to that in the actual ad copy to the extent that the same advertisers are represented. In various embodiments, in block 330, the actual ad copy may be created by the advertising server based on the advertisers selected and the information included in the request. In various embodiments, a copy of the ad copy may be stored in a database at the server. The ad copy will preferably include the URL of the online replica website.

In block 340, the ad copy may be transferred from the advertising server to the requesting offline media source. As discussed herein, in various embodiments, the ad copy may be created either automatically, manually or through a combination of those techniques at the advertising server side. In various other embodiments, the ad copy may be created by the offline media source based on information supplied to the offline media source, such as the advertiser name, brief product/service description and any corresponding graphics, logos, etc. as well as the URL of the online replica site for that offline media source. The ad copy or relevant information may be transferred to the offline media source by electronic means such as electronic mail, file transfer protocol or telnet, or may be transferred through conventional means such as by courier on an electronic storage media or even as a paper print out. The process ends in block 350.

Referring now to FIG. 4, a flow chart of an exemplary method for selecting particular advertisement messages to appear in the offline media in accordance with at least one embodiment of the invention is depicted. The process is initiated at block 310, where, as in block 310 of FIG. 3, a request for advertisements is received from an offline media source by the advertising server. In various embodiments, the process may begin in block 311 by determining which advertisers or ad messages are not excluded—conversely, which are available to satisfy the request. In various embodiments, this may comprise filtering the set of advertisers or advertising messages stored on the server based on the kind of publication for which the ads are intended, pricing constraints imposed by either the offline media source or the advertiser, or other advertiser and/or media source preferences. In various embodiments this may result in a subset of potential advertisers or messages that is less than equal to the total number stored on the server. Then, in block 312, based at least in part on pricing conditions, the server determines which ads from those that are relevant and not excluded, are available for publication in the offline media source. In various embodiments, an algorithm, routine or criteria may be applied that maximizes potential advertisement revenue. This may comprise a price auction whereby advertisers have previously specified a range or maximum amount they are willing to pay for advertising and the advertisers that will maximize potential revenue may be selected. However, revenue maximization may be only one of several factors influencing the selection process.

In block 313, after the winning advertiser or advertisers have been selected, the actual ad copy to appear in the offline media source may be created. In various embodiments, this may be based on the amount and/or dimensions of available advertising space in the offline media source. However, as discussed above, in various embodiments, the actual ad copy may be created at the server side of the system so that the offline media source merely “inserts” the ad copy into the available space. In various embodiments, the ad copy may be created at the offline media source side based on information received from the advertising server regarding the advertisements selected to appear. Furthermore, in block 313, an online replica website may also be created. The online replica website may contain an online version of the offline ad copy that appears in the offline media source. The online replica site may also contain additional information such as graphics, more detailed descriptions and hyperlinks to each of the represented advertisers' respective websites. Regardless of whether the ad copy is created entirely at the advertising server side or at the offline media source side based on information supplied by the advertising server side, the ad copy appearing in the offline media source may preferably contain the URL of the online replica website so that customers seeking additional information on the products and/or services being advertised can be directed to the respective advertisers' websites through a central website associated with the particular offline media source, and the advertisers may be charged using an Internet-type pricing and usage model such as, for example, cost-per-click or referral basis.

In block 314 an outbound message may be sent to the requesting offline media source. In various embodiments, the message may contain either the ad copy selected by the server or information on the one or more selected advertisers, including the URL for the online replica site. In block 315 processing returns to the process of FIG. 3

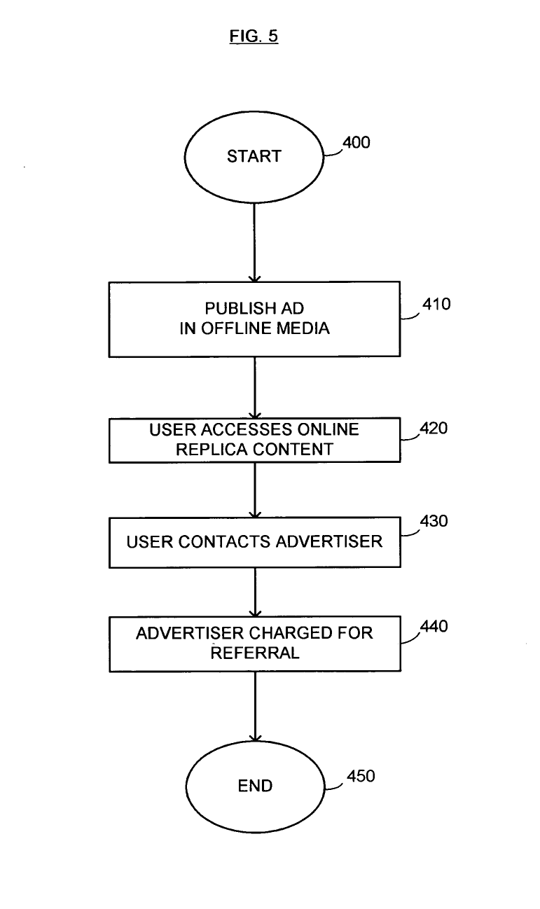

Referring now to FIG. 5, a flow chart of an exemplary method for realizing revenue through an online pricing and usage model for print advertisements according to at least one embodiment of the invention is depicted. Operation begins in block 400. In block 410, the advertisement may be published in the offline media. As discussed herein, this may be a newspaper, journal, magazine, or even on television. In various embodiments, the ad copy may include the URL of the online replica website so that the user can contact advertisers through a channel that allows the recovery of ad revenue.

In block 420, the user may navigate to the online replica website by entering the URL that appears in the ad from the offline media source. In various embodiments, the website may contain individual advertisements from each of the advertisers that were selected in the process of FIGS. 3 and 4. In various embodiments, the online replica site may appear the same as that in the offline media source. In various embodiments, the online replica site may merely be similar to that appearing in the offline media source. In various embodiments, each represented advertiser may include a clickable hyperlink allowing viewers to navigate automatically to the individual websites associated with each advertiser.

In order to prevent or dissuade viewers from going directly to the advertiser's individual websites without going through the online replica site several techniques may be used. Firstly, in various embodiments, the ad appearing in the offline media source may not contain a URL or telephone number for the individual advertisers. Thus, viewers wishing to contact the advertisers may go to the online replica site to obtain the necessary information to contact the advertiser. This may be particularly effective for advertisers that are not well known and/or do not have well known and/or easily discernable website addresses. However, given the pervasive use of Internet search sites, such as Google and Yahoo, various embodiments, may provide an incentive for viewers to contact the advertisers through the online replica site rather than searching for it on their own. For example, viewers may be provided with an incentive such as free shipping, a percentage discount, or other financial incentive as a reward for contacting the advertiser through the online replica site. Because in the various systems and methods according to the invention, ad revenue may only be generated when users click through from the replica site to the advertiser's site, free riding is a problem. Free riding occurs when the system is used to place an ad in offline media source and the viewer contact the advertiser because of the ad but without using the online replica site. In such cases the advertiser essentially receives free advertising. Thus, by excluding contact information and providing the viewer with an incentive only available by going to the online replica site, free riding may be reduced.

Furthermore, it should be noted that in various embodiments, when the user visits the online replica site, a real time auction may be conducted to determine exactly which advertisements appear on the online replica site. That is more, less or different ads may appear than those that appeared in the offline media source. In various embodiments, this may be transparent to the person visiting the online replica site.

In block 440, the user, after navigating to the online replica site, clicks on a hyperlink that takes him/her to the corresponding advertiser's website. Using well known web-based referral tracking techniques, a data record may be created acknowledging the fact that a user was directed to advertiser A's website through the online replica site. If the advertiser has a pricing contract specifying a fixed price per click-through or referral-based sale with the advertising server system, the advertiser may be charged accordingly. Therefore, accordingly to the various systems and methods of the embodiments of the invention, traditional online retailers may benefit from web-based referrals that are initiated through offline media advertising. Moreover, offline media sources may be able to sell incremental unallocated space to a market not previously available to them on a “last minute” basis. It is envisioned that the entity maintaining the advertising server may contract for payment from the advertisers and may pay a percentage of revenue realized to the offline media source running its ads, although this type of arrangement is not required. The offline publisher may maintain its own advertising server for contracting directly with advertisers. Operation terminates in block 450.

### Exemplary Embodiment

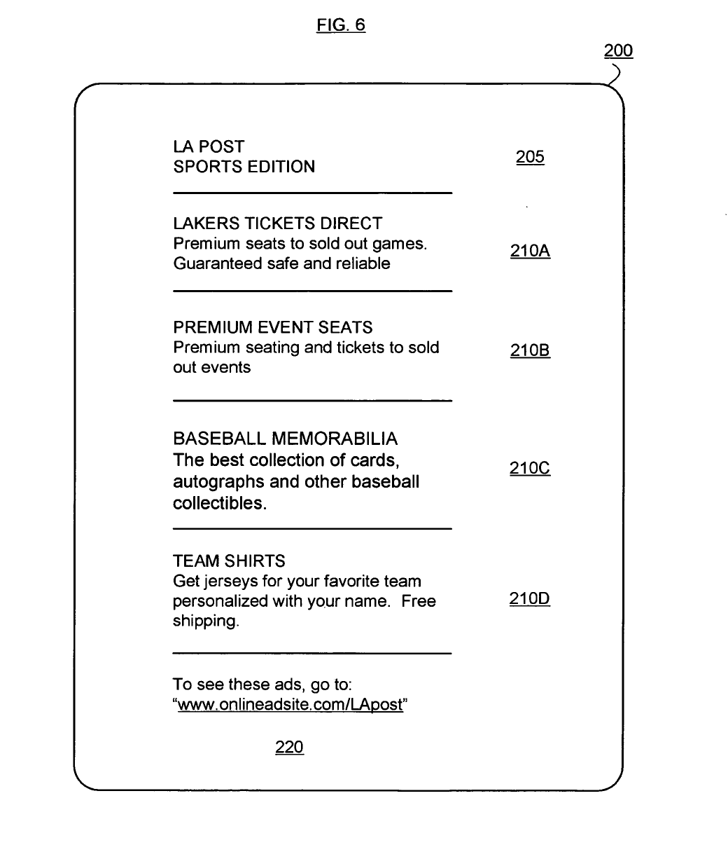

Referring now to FIG. 6, a sample offline advertisement copy generated by the system for allocating available advertising space in an offline media using an online usage and pricing model according to at least one embodiment of the invention is depicted. The sample advertisement copy 200 may include ad messages intended for the sports section of a fictitious newspaper called the LA Post. The ad copy 200 may include a header section 205 identifying the offline media source and a plurality of ad messages 210A, 210B, 210C and 210D. Because the ad may appear in the sports section of the paper, in this example, ad messages that were either designated by the advertiser or determined by the ad server to be relevant to the sports page reader demographic have been selected. In this example, there are ad messages for sporting events tickets, sports memorabilia and other sports related merchandise. It should be appreciated, however, that other categories of ads may also be selected. In fact, the particular correlation of the type of product and/or service being advertised and the location of the ad in a publication or even the nature of the publication is not essential to the various embodiments of the invention. Ads for a variety of different products and/or services may be selected to appear in the sports section. The ad copy 200 includes a URL 220 for an online replica website corresponding to the publication, i.e., LA post. Thus, viewers of this newspaper ad 200 may be directed to navigate to the URL “www.onlineadsite.con/LApost” to obtain additional information on the advertisers.

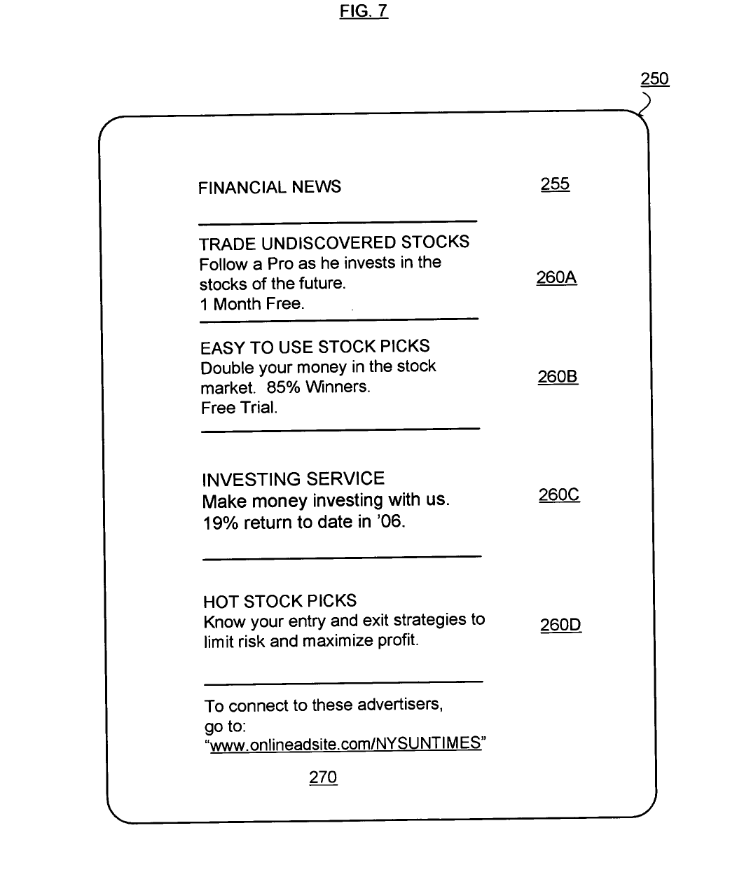

FIG. 7 illustrates another sample offline line advertisement generated by the system for allocating available advertising space in an offline media using an online usage and pricing model according to at least one embodiment of the invention. The advertisement 250 depicted in FIG. 7 is destined for a fictitious financial newspaper entitled “Financial News.” The ad 250 includes a header portion 255 that identifies the particular offline media source as well as four individual advertisement messages 260A, 260B, 260C and 260D. The particular ads have been selected by the advertising server at least in part on a determined relevance to the financial services industry. The ads offer various investment related services. As with the ad depicted in FIG. 6, the ad contains a URL 270 directing viewers to an online replica site for the Financial News where they can obtain additional information and connect to the respective advertisers. Though not depicted in either FIG. 6 or 7, the ads 200, 250 respectively may contain a written incentive to entice viewers to visit the online replica site to avoid free riding.

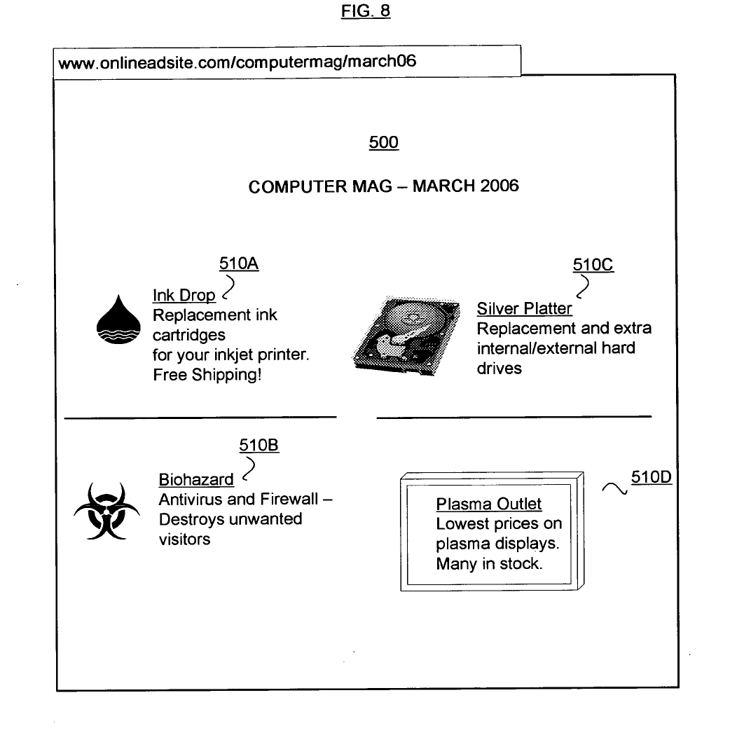

Referring now to FIG. 8, an interface (e.g., a browser window) illustrating an exemplary view of an online replica website created by the system for allocating available advertising space in an offline media using an online usage and pricing model including links to a plurality of online retailers according to at least one embodiment of the invention is depicted. The URL for the online replica website 500 in this example is “www.onlineadsite.com/computermag/march06.” In this case the online replica site was created to replicate ads created for the March 2006 edition of a fictitious PC magazine entitled “Computer Mag.” The webpage 500 includes links to four different advertisers: ink drop 510A, Biohazard 510B, Silver Platter 510C and Plasma Outlet 510D. The respective ads 510A-510D include descriptions of each of the advertisers including graphics and a hyperlink to their respective websites. In various embodiments, users may click on any of the hyperlinked descriptions and be automatically routed to the corresponding website. In such a manner, the advertising server may collect revenue for advertising from the respective advertisers. Revenue may be based on simple click through or may be based on sales generated by customers accessing through the online replica site. The particular pricing model used with the advertiser is not critical to the various embodiments of the invention. Rather, the various embodiments of the invention provide a way for variety of different Internet-type advertising pricing and usage models to be used to purchase ad space in offline media sources.

Thus, the various systems and methods for allocated unused offline media source advertising space to online advertisers using online pricing and usage models may benefit both advertisers and media publishers. Furthermore, because an infinite number of websites may be created with relative ease, the system is not subject to the constraints of conventional systems that use a dedicated telephone number. Also, offline publishers can obtain incremental advertising revenue on a short notice basis reaching a demographic that may not otherwise be willing to pay for offline ad space. Furthermore, free riding may be reduced by providing only the web address of the online replica site and/or through other incentives.

It should be understood that the server, processors, and modules described herein may perform their functions (e.g., reading optical information or determining rating information) automatically or via an automated system. As used herein, the term “automatically” refers to an action being performed by any machine-executable process, e.g., a process that does not require human intervention or input.

The embodiments of the present inventions are not to be limited in scope by the specific embodiments described herein. For example, although many of the embodiments disclosed herein have been described with selling unallocated advertising space in offline media sources to online advertisers using online pricing and usage models, other embodiments, in addition to those described herein, will be apparent to those of ordinary skill in the art from the foregoing description and accompanying drawings. Thus, such modifications are intended to fall within the scope of the following appended claims. Further, although some of the embodiments of the present invention have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breath and spirit of the embodiments of the present inventions as disclosed herein.

While the foregoing description includes many details and specificities, it is to be understood that these have been included for purposes of explanation only, and are not to be interpreted as limitations of the present invention. Many modifications to the embodiments described above can be made without departing from the spirit and scope of the invention.

1. A method for allocating advertisements to offline media advertising space comprising:
receiving an indication of available advertising space from an offline media source;
selecting at least one advertisement message associated with an advertiser to use in the available advertising space;
transmitting the at least one advertisement message to the offline media source, the at least one advertisement message comprising a reference to online replica content; and
creating the online replica content.

2. The method according to claim 1, wherein receiving an indication of available advertising space comprises receiving an electronic request specifying an amount of available space.

3. The method according to claim 1, wherein selecting at least one advertisement message comprises selecting at least one advertisement message from an electronic database of electronic advertisement messages.

4. The method according to claim 1, wherein selecting at least one advertisement message comprises selecting at least one advertisement message based on a correlation between the advertisement and a target demographic of the offline media.

5. The method according to claim 1, wherein selecting at least one advertisement message comprises selecting at least on advertisement message based at least on part on advertiser specified preferences.

6. The method according to claim 5, wherein advertiser specified preferences comprise pricing preferences.

7. The method according to claim 5, wherein advertiser specified preferences comprise at least one preferred category of offline media.

8. The method according to claim 5, wherein advertiser specified preferences comprise a name of at least one specific offline media.

9. The method according to claim 1, wherein selecting at least one advertisement message comprises conducting an auction among advertisers associated with advertisement messages and selecting the at least one advertisement message based on the auction.

10. The method according to claim 1, further comprising generating an advertising copy adapted to conform to the available space and including the reference to the online replica content.

11. The method according to claim 10, wherein the creating the online replica content comprises creating a web page including the at least one advertisement message and a click-through link to a website associated with the advertisement message.

12. The method according to claim 11, wherein an advertiser associated with the at least one advertisement message is charged when a viewer clicks through to the advertiser's website from the web page.

13. The method according to claim 11, further comprising displaying the web page including the at least one advertisement message to a user who accesses the web page.

14. The method according to claim 12, further comprising conducting a real-time auction when the user accesses web page, selecting at least one advertisement message to display based at least in part on the results of the auction and displaying the at least on advertisement message including an click-though link to a website associated with the at least on advertisement message on the web page.

15. The method according to claim 1, further comprising providing an incentive to access the online replica content.

16. The method according to claim 15, wherein providing an incentive comprises providing a discount.

17. The method according to claim 16, wherein providing a discount comprises providing a discount to those viewers who reach the advertiser based on information contained in the online replica content.

18. A system for allocating advertisements to available offline media advertising space comprising:
an advertising server adapted to:
store a plurality of advertisement messages;
receive requests from offline media sources for advertisements;
select one or more advertisement messages from the plurality of messages to satisfy the request;
return an advertisement copy containing the one or more selected messages and identification information for online replica content;
create the online replica content, wherein for each of the one or more advertisement messages, the online replica content contains contact information for contacting an advertiser associated with the advertisement message; and
charge advertisers on a referral basis when a viewer contacts the advertiser using the contact information.

19. A automated method for selling advertisement space in offline media comprising:
creating a database of electronic advertising messages;
based on a received request from an offline media source for advertisement messages, generating an advertisement copy containing at least one of the electronic advertising messages;
creating an online replica content containing the advertisement copy; and
transmitting the advertisement copy to the offline media source, wherein the advertisement copy comprises identification information of the online replica content.

20. A system for selling unallocated ad space in offline media to online vendors comprising:
at least one offline media source;
a plurality of advertisement messages, each message associated with an online vendor; and
an advertisement server, wherein the advertisement server is adapted to select at least one advertisement message, create an online replica website containing the at least one advertisement message, and generate an advertisement copy containing the selected at least one advertisement message and a URL for the online replica website.
